(19) United States
(12) Patent Application Publication
(10) Pub. No.: US 2008/0208411 A1
(43) Pub. Date: Aug. 28, 2008

(54) Method for Controlling an Electric Steering Assistance System

(76) Inventor: Markus Broecker, Grevenbroich (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/885,366

(22) PCT Filed: Feb. 20, 2006
(86) PCT No.: PCT/EP2006/001509

§ 371 Date: Apr. 11, 2008

(30) Foreign Application Priority Data
Mar. 1, 2005 (DE) 10 2005 009 350.7

(51) Int. Cl. B62D 5/04

(52) U.S. Cl. 701/42

(57) ABSTRACT

In a method for controlling an electric steering assistance system having an electric motor to provide an auxiliary torque for a steering arrangement, a steering wheel torque, which is applied by the driver, is measured. The measured steering wheel torque signal undergoes high-pass filtering to determine an inertia compensation torque requirement, such that a signal is obtained which is representative of the dynamics of the steering wheel torque signal. The method according to the invention makes possible a modification of the steering wheel torque dynamics which is dependent on the steering angle velocity. An electric steering assistance system having a control arrangement to carry out the method comprises an electric motor to provide an auxiliary torque for a steering arrangement. The control arrangement has a high-pass filter in which the steering wheel torque signal undergoes high-pass filtering.

### CROSS-REFERENCE TO RELATED APPLICATIONS

This application is a National Stage of International Application No. PCT/EP2006/001509 filed Feb. 20, 2006, the disclosures of which are incorporated herein by reference, and which claimed priority to German Patent Application No. 10 2005 009 350.7 filed Mar. 1, 2005, the disclosures of which are incorporated herein by reference.

### BACKGROUND OF THE INVENTION

The invention relates to a method for controlling an electric steering assistance system having an electric motor to provide an auxiliary torque for a steering arrangement, in which a steering wheel torque, which is applied by the driver, is measured. The invention further relates to an electric steering assistance system having a control arrangement to carry out the method.

An electric steering assistance system and a method for controlling the steering assistance system of the type initially mentioned are known from EP-A-1 211 158. The auxiliary torque which is to be provided by the electric motor is calculated depending on the angular acceleration of the steering column and a parameter which is representative of the inertia of the rotor of the electric motor.

### BRIEF SUMMARY OF THE INVENTION

It is an object of the invention to provide an improved steering feel in an electric steering assistance system in a favourably-priced manner.

To achieve this object, a method of the type initially mentioned is proposed, in which the measured steering wheel torque signal undergoes high-pass filtering to determine an inertia compensation torque requirement, such that a signal is obtained which is representative of the dynamics of the steering wheel torque signal. The method according to the invention provides for an optimized compensation of the inertia feel in an electric steering assistance system. Through the high-pass filtering of the steering wheel torque signal which is provided according to the invention, the dynamics of the steering movement is also taken into account with the provision of the auxiliary torque, because the inertia compensation torque requirement for the electric motor is determined as a function of the high-pass filtered steering wheel torque signal. The method according to the invention has the advantage that input values which are picked up as standard in electric steering assistance systems are used to determine the inertia compensation torque requirement. Therefore, no additional sensors are necessary; only the programming of the control arrangement has to be modified. The approach according to the invention for determining the inertia compensation torque requirement is very flexible and can be easily adapted to various requirements regarding the steering feel.

According to a preferred embodiment of the invention, the specified inertia compensation torque requirement flows into an assistance- and stability regulating path to control the electric steering assistance system. The additional control component according to the invention therefore leads to a stable control system.

Further advantageous and expedient developments of the method according to the invention will be apparent from sub-claims 2 to 7.

The invention also provides an electric steering assistance system having a control arrangement to carry out the method according to the invention: The electric steering assistance system comprises an electric motor to provide an auxiliary torque for a steering arrangement. The control arrangement has a high-pass filter in which the steering wheel torque signal undergoes high-pass filtering.

Advantageous and expedient developments of the electric steering assistance system according to the invention will be apparent from sub-claims 9 to 12.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a block diagram of an auxiliary torque control arrangement for an electric steering assistance system according to the invention; and

FIG. 2 shows a block diagram for calculating the inertia compensation torque requirement.

### DETAILED DESCRIPTION OF THE INVENTION

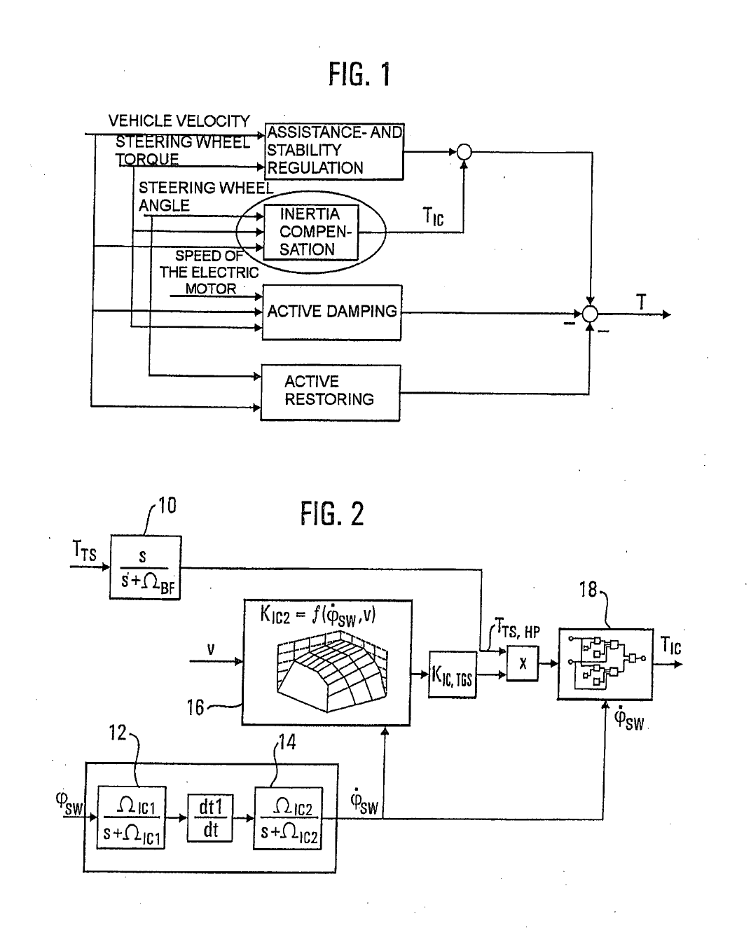

The block diagram in FIG. 1 shows how the torque requirement T for the electric motor is determined to achieve an improved steering feel in an electric steering assistance system according to the invention, having an electric motor to provide an auxiliary torque for a steering arrangement (steering shaft—or steering member arrangement). The contributory parts from which the torque requirement T is composed are determined from the input values of vehicle velocity, steering wheel torque, steering wheel angle and speed of the electric motor in different processing blocks. The determining of the inertia compensation contributory part T_{IC} which flows into the assistance- and stability regulating path of the steering assistance control arrangement is described below.

FIG. 2 shows how the inertia compensation contributory part (inertia compensation torque requirement) T_{IC} is determined from the input values of steering wheel torque T_{TS}, vehicle velocity v and steering wheel angle of rotation φ_{SW}.

The steering wheel torque T_{TS} which is applied by the driver is measured with the aid of a suitable sensor. In a high-pass filter 10 with the filter frequency Ω_{BF}, the measured signal T_{TS} is converted into a signal T_{TS,HP}, which is representative of the dynamics of the measured steering wheel torque signal T_{TS}.

The steering wheel angle φ_{SW}, i.e. the turning angle of the steering wheel starting from a zero position, is likewise measured, and the corresponding signal is supplied to a first low-pass filter 12 with a first filter frequency Ω_{IC1}. The low-pass filtered signal is differentiated according to time and undergoes a further low-pass filtering in a second low-pass filter 14 with the second filter frequency Ω_{IC2}.

The resulting steering wheel angle velocity signal φ_{SW} is supplied together with the current vehicle velocity v to an assignment system 16 with a multidimensional set of characteristic curves. A predetermined inertia compensation factor K_{IC2} is assigned in the assignment system to the combination of these two input values φ_{SW}, v. The high-pass filtered steering wheel torque signal T_{TS,HP} is multiplied with the inertia compensation factor K_{IC1} and the sign factor K_{IC,TGS}.

The result of this multiplication, together with the low-pass filtered steering wheel angle velocity signal φ_{SW}, is supplied to a sum calculation system 18. In the sum calculation system 18, the precise direction of the inertia compensation torque requirement T_{IC} is calculated as a function of the steering wheel angle velocity φ_{SW}. The linear calculation of the inertia compensation torque requirement T_{IC} can be described by the following equation:

T_{IC}=T_{TS,HP}*K_{IC,TGS}*K_{IC2}(φ_{SW}, v)

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A method for controlling an electric steering assistance system having an electric motor to provide an auxiliary torque for a steering arrangement, in which a steering wheel torque, applied by the driver, is measured to determine a measured steering wheel torque signal, characterized in that the measured steering wheel torque signal undergoes high-pass filtering to that obtain a high pass filtered steering wheel signal which is representative of the dynamics of the steering wheel torque signal, the high pass filtered steering wheel signal being utilized to determine an inertia compensation torque requirement.

2. The method according to claim 1 wherein the determination of the inertial compensation torque requirement also includes measuring a steering wheel angle to determine a corresponding steering wheel angle signal and further wherein the corresponding steering wheel angle signal undergoes low-pass filtering.

3. The method according to claim 2 wherein the low-pass filtered steering wheel angle signal is differentiated according to time and undergoes low-pass filtering again to obtain a steering wheel angle velocity signal.

4. The method according to claim 3 wherein the steering wheel angle velocity signal and a current vehicle velocity signal are supplied to an assignment system and further wherein the assignment system assigns a predetermined inertia compensation factor to a combination of the steering wheel angle velocity signal and the current vehicle velocity signal.

5. The method according to claim 4 wherein the determination of the inertial compensation torque requirement also includes multiplying the high-pass filtered steering wheel torque signal with the inertia compensation factor and a sign factor.

6. The method according to claim 5 wherein the direction of the inertia compensation torque requirement is calculated as a function of the steering wheel angle velocity in a sum calculation system.

7. The method according to claim 6 wherein the specified inertia compensation torque requirement flows into an assistance- and stability regulating path to control the electric steering assistance system.

8. An electric steering assistance system comprising:
an electric motor to provide an auxiliary torque for a steering arrangement; and
a controller connected to said electric motor, said controller operable to measure a steering wheel torque applied by a driver and to determine a measured steering wheel torque signal, the controller including a high-pass filter in which the steering wheel torque signal undergoes a high-pass filtering to determine a high pass filtered steering wheel signal which is representative of the dynamics of the steering wheel torque signal, the controller utilizing the high pass filtered steering wheel signal to determine an inertia compensation torque requirement.

9. The electric steering assistance system according to claim 8 wherein the controller also includes a first low-pass filter having a first filter frequency for low-pass filtering of a steering wheel angle signal.

10. The electric steering assistance system according to claim 9 wherein the controller is operative to differentiate the low-pass filtered signal according to time and further wherein the controller further includes a second low-pass filter having a second filter frequency for low-pass filtering the differentiated steering wheel angle signal to produce a steering wheel angle velocity signal.

11. The electric steering assistance system according to claim 10 wherein the controller also includes an assignment system which determines an inertia compensation factor as a function of the steering wheel angle velocity signal and a vehicle velocity.

12. The electric steering assistance system according to claim 13 wherein the controller further includes a sum calculation system in which the precise direction of the inertia compensation torque requirement is calculated as a function of the steering wheel angle velocity.

13. The electric steering assistance system according to claim 11, wherein the controller is further operative to determine the inertial compensation torque requirement by multiplying the high-pass filtered steering wheel torque signal with the inertia compensation factor and a sign factor.
